(19) United States
(12) Patent Application Publication
(10) Pub. No.: US 2013/0024930 A1
(43) Pub. Date: Jan. 24, 2013

(54) Executing Functions of a Secure Program in Unprivileged Mode

(71) Applicants: Michael Steil, San Francisco, CA (US); Benjamin H. Byer, San Jose, CA (US)

(72) Inventors: Michael Steil, San Francisco, CA (US); Benjamin H. Byer, San Jose, CA (US)

(21) Appl. No.: 13/187,303

(22) Filed: Jul. 20, 2011

(51) Int. Cl. G06F 21/22

(52) U.S. Cl. 726/16; 726/17

(57) ABSTRACT

Executing functions of a secure program in unprivileged mode. A program may be executed in a supervisory mode. The program may call multiple functions. Each function may be executed in a unprivileged mode. Additionally, each function may be executed in a respective constrained environment or sandbox. Each constrained environment may be dedicated to or customized for the respective function. For example, each constrained environment may have a set of privileges that are based on the respective function executing within the constrained environment.

### BACKGROUND

1. Field of the Invention

This invention relates to secure program execution, and more particularly, to methods and mechanisms to execute functions of secure programs in unprivileged mode.

2. Description of the Related Art

In recent years, a multitude of electronic devices have been created and used. During initialization or bootup of these devices, bootloaders generally execute code that leads to the initialization of an operating system. For example, a series of code may be executed until the system is booted. Many systems implement “chain-of-trust” code where initial trusted code is executed (e.g., that is stored in read-only memory or in a trusted memory) and hands off execution to another piece of code only if that code has been verfied as authentic. However, these boot-up sequences (and bootloaders in general) are vulnerable to various attacks and exploits in order to execute unauthorized code. For example, in code execution exploits, an attacker may change the program counter to point to injected “shell code”, causing normal code verification to be skipped. In return-to-lib exploits, the attacker may change the program counter to a different location in existing code to shortcut a function or make a function return a different result. A related technique changes a return value on the stack without modifying or interacting with the program counter. In global data corruption exploits, the attacker may overwrite the global state of the program causing different decisions to be made later. In logic error exploits, the attacker may trigger an edge case (or other bug) that is handled incorrectly by the code. These exploits have been used to attack various popular devices, such as the Apple iPhone, Microsoft Xbox, Nintendo Wii, Sega Dreamcast, etc.

In addition to bootloaders or code used during initializations of systems, similar exploits may be used in other programs that may be valuable to exploit, such as programs handling financial information, personal user information, database applications, etc.

### SUMMARY

Various embodiments are described of a method for executing functions of secure programs in unprivileged mode.

A program may be loaded from storage into memory and then executed by software. The program may be any type of program that is to be executed in a secure manner, but in specific embodiments, may be a bootloader program. For example, the bootloader program may be loaded from a single memory (e.g., read-only memory (ROM)) or may be loaded from multiple of memories over time (e.g., where an initial portion of the bootloader is loaded which loads other portions of the bootloader). The various memories may be read-only or read-write, as desired.

The program may be executed by a processor. The program may execute in a supervisory or kernel mode of the processor (or of the operating system). Additionally, the program may include multiple function calls, which each reference respective functions (e.g., whose program code may be stored in different files or memory locations). Each of the functions may be called from the program and may execute in a unprivileged mode (e.g., user mode) of the processor (or of the operating system). Additionally, each of the functions may be executed in a respective constrained environment or sandbox. For example, the constrained environment may be created or customized for each of the functions that are called, e.g., having a restricted set of privileges, memory access, input access, output access, etc. that is specifically created for the respective function. These constrained environments may be created and destroyed before and after, respectively, the function is executed (e.g., where the creation happens after a previous function has finished executing and the destruction happens before a next function has begun executing).

### BRIEF DESCRIPTION OF THE DRAWINGS

The following detailed description makes reference to the accompanying drawings, which are now briefly described.

FIGS. 1A and 1B illustrates exemplary systems, according to various embodiments;

FIG. 2 is a block diagram of an exemplary device, according to one embodiment;

FIG. 3 is a flow diagram of one embodiment of a method for executing functions of secure programs in unprivileged mode; and

FIGS. 4-6 are further Figures corresponding to the method of FIG. 3.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits and/or memory storing program instructions executable to implement the operation. The memory can include volatile memory such as static or dynamic random access memory and/or nonvolatile memory such as optical or magnetic disk storage, flash memory, programmable read-only memories, etc. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six interpretation for that unit/circuit/component.

### DETAILED DESCRIPTION OF EMBODIMENTS

### Terms

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a flash memory, magnetic media, e.g., a hard drive, or optical storage; registers, or other similar types of memory elements, etc. The memory medium may include other types of memory as well or combinations thereof. In addition, the memory medium may be located in a first computer in which the programs are executed, or may be located in a second different computer which connects to the first computer over a cable, such as USB, or over a network, such as the Internet. In the latter instances, the second computer may provide program instructions to the first computer for execution. The term “memory medium” may include two or more memory media which may reside in different locations, e.g., in different computers that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), mainframe computer system, workstation, network appliance, Internet appliance, personal digital assistant (PDA), personal communication device, smart phone, television system, grid computing system, or other device or combinations of devices. In general, the term “computer system” can be broadly defined to encompass any device (or combination of devices) having at least one processor that executes instructions from a memory medium.

Portable Device—any of various types of computer systems which are mobile or portable, including portable gaming devices (e.g., Nintendo DS™, PlayStation Portable™, Gameboy Advance™, iPhone™), laptops, PDAs, mobile telephones, handheld devices, portable Internet devices, music players, data storage devices, etc. In general, the term “portable device” can be broadly defined to encompass any electronic, computing, and/or telecommunications device (or combination of devices) which is easily transported by a user.

Communication Device—any of various devices which are capable of communicating with other devices, e.g., wirelessly. Communication Device is a superset of portable devices with communication capabilities (e.g., a Communication Device may be portable or stationary). Communication devices include cell phones, wireless access points (e.g., wireless routers) and other devices capable of communicating with other devices.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

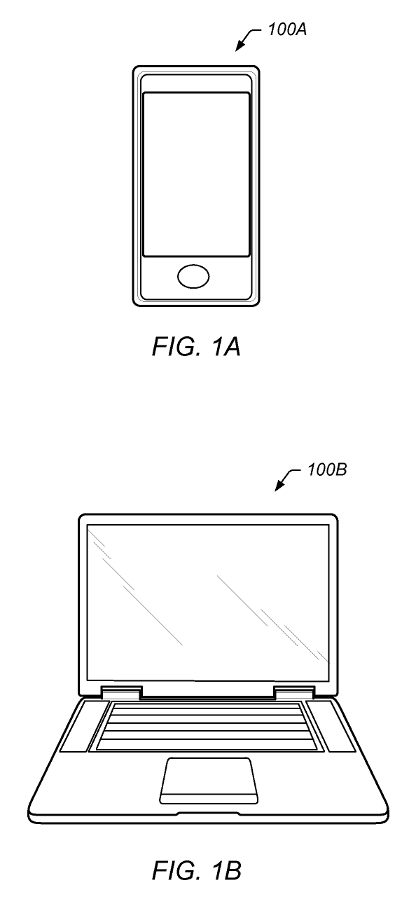

### FIGS. 1A-1B—Exemplary Systems

FIGS. 1A and 1B illustrate exemplary systems that may implement embodiments described herein. More particularly, FIGS. 1A and 1B illustrate exemplary devices 100A and 100B (referred to collectively as “device 100”). The device 100 may be any of a variety of devices. For example, the device 100 may be a portable or mobile device, such as a mobile phone (e.g., 100A in FIG. 1A), PDA, audio/video player, etc. The device may also be any of various other devices, such as computer systems, laptops (e.g., 100B in FIG. 1B), netbooks, tablets, etc. In one embodiment, the device 100 may be a wireless device that is configured to communicate with other devices (e.g., other wireless devices, wireless peripherals, cell towers, access points, etc.) using one or more wireless channels. As used herein, a “wireless device” refers to a device that is able to communicate with other devices or systems using wireless communication. For example, the device 100 may be configured to utilize one or more wireless protocols, e.g., 802.11x, Bluetooth, WiMax, CDMA, GSM, etc., in order to communicate with the other devices wirelessly. In embodiments described herein, the device 100 may be configured to control performance of one or more processors of the device 100.

As also shown in FIGS. 1A and 1B, the device 100 may include a display, which may be operable to display graphics provided by an application executing on the device 100. The application may be any of various applications, such as, for example, games, internet browsing applications, email applications, phone applications, productivity applications, etc. The application may be stored in a memory medium of the device 100. As described below, the device 100 may include a processor (e.g., a CPU) and display circuitry (e.g., including a GPU) which may collectively execute these applications.

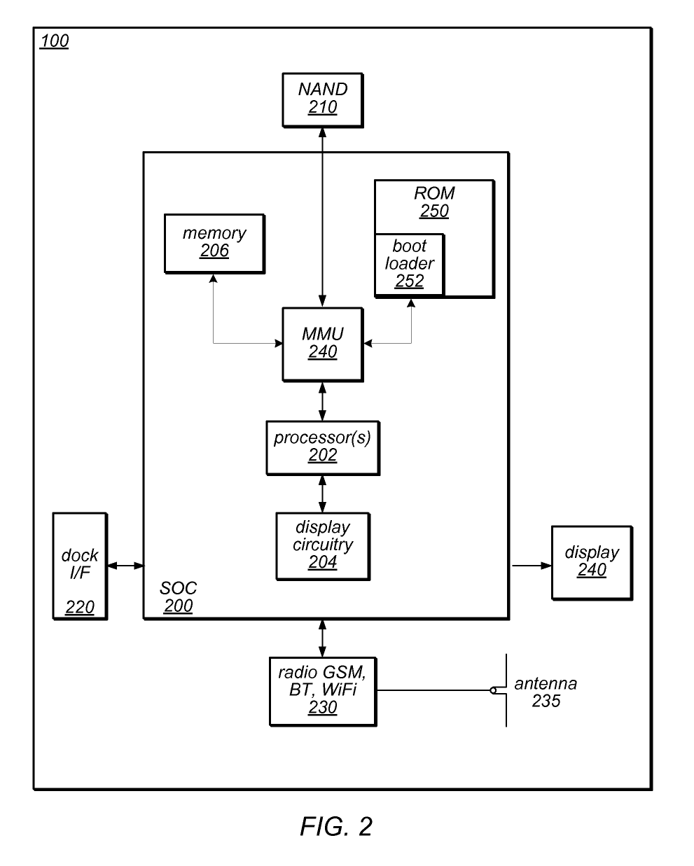

### FIG. 2—Exemplary Block Diagram

FIG. 2 illustrates an exemplary block diagram of the device 100. As shown, the device 100 may include a system on chip (SOC) 200, which may include portions for various purposes. For example, as shown, the SOC 200 may include processor(s) 202 which may execute program instructions for the device 100 and display circuitry 204 which may perform graphics processing and provide display signals to the display 240. The processor(s) 202 may also be coupled to memory management unit (MMU) 240, which may be configured to receive addresses from the processor(s) 202 and translate those addresses to locations in memory (e.g., memory 206, read only memory (ROM) 250, NAND flash memory 210) and/or to other circuits or devices, such as the display circuitry 204, radio 230, connector I/F 220, and/or display 240. The MMU 240 may be configured to perform memory protection and page table translation or set up. In some embodiments, the MMU 240 may be included as a portion of the processor(s) 202.

In the embodiment shown, ROM 250 may include a bootloader 252, which may be executed by the processor(s) 202 during boot up or initialization. In some embodiments, ROM 250 may be external to the processor(s) 202 as shown, or may be included as a portion of the processor(s) 202. While the bootloader 252 is shown as only being stored in ROM 250, it may be distributed among any number of memories or types of memories. For example, the bootloader may not necessarily be stored in ROM. In one embodiment, an initial portion of the bootloader may be executed from ROM and it may specify execution of other portions of the bootloader which may be stored in other memories (e.g., memory 206, NAND Flash memory 210, or other memories). For example, the entire bootloader may be too large to be stored in ROM 250, so the initial portion may load, verify and execute a later portion of the bootloader stored in a different memory, such as NAND flash 210 (although other types of memories besides NAND flash are envisioned, such as any type of non-volatile memory). Where the bootloader is distributed, each portion may be referred to as a portion of a bootloader or as an individual bootloader, as desired. For example, where the bootloader is distributed amongst three memories, it may be referred to as a single bootloader that is distributed or three separate bootloaders that are executed in sequence, as desired. Further details regarding executing of bootloaders or other programs that require security are provided below.

As also shown, the SOC 200 may be coupled to various other circuits of the device 100. For example, the device 100 may include various types of memory (e.g., including NAND flash 210), a connector interface 220 (e.g., for coupling to the computer system), the display 240, and wireless communication circuitry (e.g., for GSM, Bluetooth, WiFi, etc.) which may use antenna 235 to perform the wireless communication. As described herein, the device 100 may include hardware and software components for monitoring processing states and modifying performance.

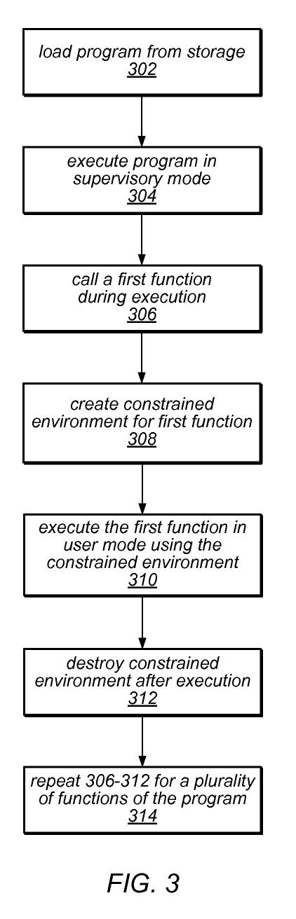

### FIG. 3—Executing Portions of a Program in Unprivileged Mode

FIG. 3 illustrates one embodiment of a method for executing functions of secure programs in unprivileged mode (e.g., user mode). The method shown in FIG. 3 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 302, the program may be loaded from storage. For example, the storage may be a ROM or may be any type of memory, as desired. When loaded from ROM, the program may be considered “trusted” since ROM cannot be changed after being initially written. However, in embodiments where the program is loaded from read-write memory, the program may be verified, e.g., by comparing an expected signature with a generated signature (e.g., comparing an encrypted hash value to a calculated hash value of the data, or by verifying that an RSA signature is a valid signature of a known RSA key pair). Similar statements may be applied for verification of any of the code (e.g., of the called functions) described herein.

In some embodiments, the program may be a bootloader for initializing a device, e.g., and eventually loading the operating system of the device. As indicated above, the bootloader may be located in a single memory or may have multiple stages (or multiple bootloaders) distributed across more than one memory or memory location. However, while bootloaders or similar initialization routines are emphasized in the current description, the program may be any type of program that is desired to be run securely. For example, the program may involve the handling and processing of bank data, transaction data, or any type of financial data, personal user information, or any type of data that has value.

In 304, the program may be executed by at least one processor. The program may be executed in a kernel mode or supervisory mode of the processor and may include multiple function calls to functions. These functions may be stored as code in memory and may be executed in unprivileged mode, as described below.

For example, the source of the program may be organized such that there is a “kernel” area of memory or directory that may include main code flow and MMU instructions and a “user” area of memory or directory that may include the individual functions. In the “user” directory, there may be a subdirectory per function, for example, there may be a subdirectory for the function “sha1”. Each of these directories may have the actual code (e.g., C code) and a description file that contains information (e.g., metadata) on how many parameters the function takes as inputs and outputs, and whether it needs access to hardware devices, among other possibilities. Thus, each function may be compiled into a separate intermediate file.

The MMU instructions may specify the normal calling interface the main code flow expects, for example “sha1(void*input, int length, void*output)”, and may specify page tables for unprivileged mode, jumps to the function in unprivileged mode, on return, tear down of the pagetables, and returns to the caller. Thus, within the main program or codeflow that executes in kernel mode, functions may be called normally. The functions may behave like normal functions (e.g., C functions), but each of them may first call out into (shared) pagetable management code and switch to unprivileged mode, before jumping into the function. Thus, in one embodiment, the “kernel” area of memory may have two sections: one with the main codeflow, and one with helper routines that set up pagetables and switch modes, which is getting called by the generated code of the respective unprivileged mode functions.

In 306, during execution of the program, the program may call a first function. For example, the main code of the program may include a call to a function with specification of one or more inputs or outputs.

In 308, a constrained environment (or “sandbox”) may be created for the first function. For example, during creation of the constrained environment, zero or more “input” memory areas may be assigned to the function. These input memory areas may be read-only. Additionally, zero or mode “output” memory areas may be assigned to the functions. These output memory areas may be cleared before invocation for protection. Additionally, zero or more “I/O” memory areas may be assigned to the function. These I/O memory areas may be used to access certain hardware devices.

Additionally, the constrained environment may specify privileges for the function. For example, for each of the assigned memory areas, the function may only have specific privileges for the respective memory area (e.g., read only for input, read write for output, executable for the portion of memory storing the function's code, read write for stack, etc.).

The constrained environment for the first function may be a custom constrained environment that is specifically designed for the first function. For example, the constrained environment may be designed to provide only the amount of privileges and access as is required by the first function, but no more. For example, a first function that receives a single input and provides a single output that does not require access to devices may only be allowed to access the data of that single input (e.g., and no other data) and access to a memory location for writing the single output. That first function may not have access to devices or any other unnecessary portions of memory. Accordingly, because the first function is in such a tightly constrained environment, an attack on the input processing code for that function would ultimately be fruitless since the function has such limited access or ability to modify other functions or data values. Further exemplary details regarding the constrained environment and design principles are provided below.

In 310, the first function may be executed using the constrained environment. As indicated above, the first function may execute in a unprivileged mode of the processor rather than the supervisory or kernel mode of the program (or the main code of the program).

In 312, after completion of the first function, the constrained environment may be torn down or destroyed. For example, the assigned memory areas may be cleared of data (e.g., after retrieving the outputs from the first function) to prevent data leakage.

In 314, 306-312 may be repeated for multiple different functions. The constrained environments may be created and torn down between execution of each of the functions. Additionally, each constrained environment may be customized for each function, so the respective constrained environments may differ significantly from function to function.

### Further Exemplary Details

The following section provides further exemplary details corresponding to the method of FIG. 3. These details are provided as examples only and are not intended to limit the scope of the embodiments described above.

Basic Design:

In this design, code may be partitioned into small jobs, and the principle of least privilege may be applied to them. There may be two types of code: main code flow, and worker functions (“jobs”). Main code flow may be trusted and bug-free. It is supposed to be minimal, so it may only include function calls into jobs and make trivial decisions. Since it is likely that at least some of the jobs will have bugs, they may be considered untrusted, and therefore they are sandboxed. Accordingly, the program may be secured by limiting the ability of a job to affect other jobs, and allowing as little influence on main code flow as possible. The sandboxing may be enforced by the privileged and unprivileged modes of a CPU: While main code flow runs in kernel mode, all jobs are run in unprivileged mode. A function call to a job switches into unprivileged mode and sets up the page tables to limit the privileges of the job, and the final “return” inside the job will switch back to kernel mode. For example, the top level return address in unprivileged mode can be 0, so it will fault and return to kernel mode.

Design Principle 1: Minimal Privilege: Each job may be assigned only the minimal amount of resources (code, memory, input data) it requires to perform its function.

Code: The job's code may be mapped executable, but read-only (r-x), and only code that is reachable by normal code flow may be mapped. This can be achieved by aligning each job's code to the start of a page boundary, so mapping memory with a page granularity will not map foreign code. As a consequence of this (without making the design too complicated), no two jobs can have common subroutines.

Stack: The job's stack may be mapped read-write and non-executable (rw-). Each job may only have as much stack mapped as is necessary.

MMIO: If the job needs to access memory-mapped I/O devices, these are mapped read-only or read-write (depending on whether write-access is required), and non-executable. Good system design should already have made sure that MMIO registers are spread widely enough in the address space so that mapping one page does not allow access to completely different devices/functions.

Inputs: All inputs to the function may be mapped read-only, and non-executable (r--). The input data only contains what is necessary for the job.

Outputs: All outputs of the function are mapped read-write and non-executable (rw-), and the memory region may be cleared before the job starts.

As a consequence of the strict separation of inputs and outputs, a function that parses data and returns a part of the input (e.g., a parser that extracts a name from a certificate) cannot simply return a pointer to an offset within the input buffer and a size, since main code flow will not touch the output itself but pass it into another job. On most processors, an arbitrary section in memory cannot generally be protected with pagetables down to byte granularity. Consequently, an attempt to pass this pointer to another job would leak data (in this example, information before and after the name extracted from the certificate). To prevent this, parser jobs (and other similar jobs) may copy the necessary data from their inputs to their outputs.

Design Principle 1 makes Code Execution (malicious code injection) exploits impossible, since only read-only code is executable (WAX). There is no way for a job to change page protections, because pagetables are not accessible from the job's sandbox. There is no way to trick kernel mode into changing protection (e.g., by calling back into kernel functions with invalid parameters), since calling back into the kernel code from a job is forbidden by this design. Even if code execution were possible, it holds little value. Any injected code would be restricted inside the same simple sandbox. Return-to-Lib exploits will be much harder, because there is very little code mapped and accessible to the job at any given moment, but smashing the stack may still allow an attacker to point the program counter to a “return TRUE”, altering the output of the function. Data Corruption exploits will be impossible, because no job has access to kernel state or data of another job. As an added benefit, the work required to partition the functionality of the program may help decrease the likelihood of Logic Errors by requiring careful attention to architecture and coding style.

Design Principle 2: Minimal Power: No job alone may be powerful enough to influence main (kernel) code flow in a way that would benefit an attacker.

In practice, this means that there should not be any jobs that perform complex operations such as checking signatures, but return very small amounts of data like a single TRUE or FALSE value. Instead, a signature check may be broken into at least three jobs: 1) hash the data, 2) decrypt the signature, and 3) compare the hash and the decrypted signature. In this example, jobs 1 and 2 return 20 bytes of data, and an explot that trickts them into returning incorrect data chosen by the attacker will have to be complex enough to return these 20 bytes instead of a single TRUE/FALSE value. The comparison job (3) still has enough power so that the attacker can make an incorrect signature pass by tricking it into returning a single flipped bit, but in practice, a compare of 20 bytes can be done bug-free and can be considered trusted. For consistency, the comparison could be done in main code flow.

But even though unlikely, a hash function may be exploited to return the hash of the expected data instead of the hash of the actual data to make the signature check pass. In order to counter this, one solution is to have two independent implementations (different codebases) of the same function and have main code flow compare their output and only continue if they match. This takes away power from Logic Errors and Return-to-Lib exploits: Even if the attacker can make the job return incorrect data, this still is not enough to compromise the overall security. It may be necessary to exploit at least two jobs for this. This principle can be made stricter to require a combination of any two, three . . . jobs not be powerful enough to compromise security.

When separating out the functions into unprivileged mode jobs, sometimes it is still possible to hack just a single job to compromise the system. For example, an attacker can convince a “hash” function (like SHA1) to not return the actual hash of attacker-manipulated data, but rather an incorrect result which matches that of unaltered data.

The proposed system makes it easy to duplicate jobs and, for instance, run two different SHA1 implementations or two different RSA (Rivest, Shamir, Adleman cryptography) implementations one after the other, comparing their results. Thus, an attack on one implementation of a critical function will not full compromise the security of the system.

Design Principle 3: Minimal Interfaces:

The data interfaces between main code flow and jobs should be minimal. Applying Design Principles 1 and 2 completely would require putting each assembly instruction into its own job. This would maximize the data passed through job interfaces and make main code flow significantly more complex to design (and therefore more difficult to implement correctly). In practice, Design Principles 1 and 2 contradict Principle 3, so a balance between these rules must be found.

Additional Principles:

1. Since the weakest links here are the hash (SHA1) and signature decryption (RSA) components (exploiting one of them in an arbitrary way is enough to compromise the whole system), as indicated above, two independent implementations of each may be implemented: one using the hardware engine, and one doing the calculation in software. Alternatively, two completely different sets of algorithms may be used (e.g. SHA1/RSA and SHA256/ECDSA), and two separate signatures may be verified by distinct code paths.

2. Every function may be designed to return TRUE if successful, so every caller should test this and bail out as soon as possible if there was a failure. This causes all the “if (! . . . ) return;” statements in the code, flattening the control flow and making it easier to read and audit.

3. The main code should distinguish between failures caused by tampering (e.g. a signature failure) and benign failures (e.g. transmission timeout). In case of tampering, the kernel should panic, otherwise it can retry or revert to other means of booting. As used herein, a “panic” (or “kernel panic”) refers to a halt of execution without the option to continue, requiring some type of restart. Exemplary actions performed after a panic are provided below.

Design: By applying the following principles to the design of Chain-of-Trust code, it is possible to get rid of all Code Execution exploits, all Data Corruption exploits, most Return-to-Lib exploits, and many Logic Errors. In addition, remaining weaknesses will only have limited power and not necessarily compromise the complete security system.

Further Considerations:

Interrupts: This design allows for linear code execution without hardware interrupts. Unfortunately, many system designs require hardware interrupts to be used during secure code execution. This design may be enhanced to support hardware interrupts by carefully designing interrupt handlers. A job that requires interrupts may get MMIO access to the interrupt controller (as part of its specific sandbox) and can set up hardware to trigger interrupts, but the interrupt handler may be part of the trusted kernel mode code. The interrupt handler is designed to be extremely simple and predictable. All the interrupt handler does is panic in case the interrupt triggered in kernel mode, and advance the PC by one instruction of it was unprivileged mode. This way, unprivileged mode code can set up interrupts using MMIO, wait for an interrupt with a single infinite loop instruction (e.g., ‘jump-dot’), and when the interrupt fires, the handler may break the infinite loop. Interrupts cannot be abused to change main code flow, because interrupts in kernel mode will panic. This idea may be extended by creating an “enable interrupts and wait for interrupt or timeout to happen” syscall, and run user space with interrupts disabled.

An alternative possibility is to allow user space code to enable interrupts, but taking an interrupt jumps to a fixed handler in the user space module, the address of which is known to the kernel for each module (e.g., by specifying this address as part of the metadata/sandbox).

DMA: Some hardware access is only possible through Direct Memory Access (DMA). Many MMUs do not support restrictions on DMA transfers; a job that can enable DMA could overwrite global state or its pagetables to break out of unprivileged mode, or read data that it should not have access to. Ideally, DMA would be avoided and other data transfer techniques (such as PIO) would be used instead. If DMA must be used in a design, kernel code can control the DMA buffer pointer, giving a job only the privilege to start the actual transfer. Unfortunately, this gets complicated as soon as a job needs more than one DMA transfer. This would require either adding a syscall to the kernel for setting up a new DMA buffer pointer (making the base design more complex) or splitting up the device access into several jobs, one per DMA. But it is possible to securely allow DMA if the following conditions are met:

1) There is no way to do delayed DMA. The point in time when the DMA is being performed needs to be predictable.

2) No sensitive (private) data is stored in RAM. DMA could be used to dump (potentially decrypted) data from a previous boot attempt from another device, or to use data that was deliberately placed there by the attacker in a previous job to give the DMA job access to this data.

3) No critical (trusted) data or code is stored in RAM. This could be: the Chain-of-Trust code, so DMA can only be allowed if the bootloader stage is in ROM; the global state, which could allow a Data Corruption exploit (Note that the PC of main code flow is probably stored in RAM); and pagetables, which could allow Code Execution, if the attacker makes data pages that it controls readable. (Architectures with software TLB refill don't have this problem.).

In summary, to support DMA securely, data may be hidden from RAM before any DMA transfers, and data may not be trusted in RAM afterwards. Additionally, Layout Randomization of physical RAM makes it harder for the attacker to find useful data and overwrite the correct data, but physical RAM might be very small, so the locations might not be sufficiently random. It is possible to make any DMA attack pointless by clearing all of RAM before (and potentially afterwards). This would require all state of main code flow to be in CPU registers, and pagetables not to be in RAM. There are two ways to have paging enabled without pagetables in RAM: Pagetables may be stored in ROM. This requires the to be constructed at compile time. Alternatively, Page tables may be constructed at run time in RAM, all entries are loaded into the TLB (by reading a byte from every page), and then the page tables are destroyed again and the CPU's page table base pointer is set to a location in ROM that defines an invalid address space.

In another embodiment, a separate job may be created for each DMA operation since the actual DMA only requires pushing a few values into a few registers, which can be performed safely.

Additional concepts: Several additional ideas can be applied to this design to harden it further, e.g., to make remaining Return-to-Lib and Logic Error exploits harder to or even impossible to apply. Some of these ideas try to solve the same problem and are mutually exclusive, many ideas are good practice for any security code, and in any case, all these ideas are optional.

Minimizing Stack Exploits: The design already makes Code Execution impossible, but Return-to-Lib can still be done using a buffer exploit that overwrites a return value on the stack. If the caller stack is separate from the argument stack, a buffer exploit of a data structure on the stack cannot simply overwrite a return address. The ABI of the compiler can be changed to have an additional argument stack. An alternative is using Stack Canaries. But there is a way to reach an even stricter goal: It is possible to prevent an attacker from arbitrarily changing the PC if the following conditions are met:

1) Attack by controlling what gets loaded into the PC through “ret”: The caller stack is managed by the CPU, and can only be written using a “call”, but not a general-purpose write.

2) Attack by controlling what gets loaded into the PC through a register: There are no function pointers. (Compiler generated “switch” jump tables are acceptable.)

While it is possible to do without function pointers, typical CPU architectures do not support a CPU-internal caller stack. It would be possible to run all jobs inside an interpreter, at the price of a more complicated main environment and a performance penalty due to overhead. On the other hand, an interpreter would make it possible to do memory protection in software, which would allow for byte granularity.

Hardware-Accelerated Crypto: If there is hardware support for certain crypto functions, it makes sense to use it, because it makes the code in the job a lot smaller, which can help getting the number of bugs down. If a crypto job needs to be done twice by independent implementations, it may be a good idea to have one job do the work in hardware, and have the other do it in software. Using hardware crypto support opens another interesting possibility: Instead of reading the result of a hash from the hardware registers and returning them in CPU registers to the caller, the job could leave the result in the hardware registers, and main code flow could read the result from there. This way, the job cannot simply return an arbitrary hash result (given the result registers are read-only); instead, it would have to feed the original data that generates the wanted hash into the hardware. This might still be easy to exploit, if the data to be hashed has only been changed in a single byte (e.g. BEQ changed into BNE), and the job feeds in the original byte instead of the modified byte when sending the data to the hardware hash engine. But a hardware hash engine typically works by reading the memory using DMA, so the job would have to modify the byte in memory, which is impossible, because input data is read-only, so the job would have to copy the data onto the stack, which should not be big enough.

Pre-Conditions, Post-Conditions, Loop Invariants: Consistently adding pre-conditions, post-conditions and loop invariants to the code in jobs and returning FALSE if anything goes wrong makes it harder for an attacker to exploit the code in general. It also enables main code flow to bail out as soon as possible if there was a failure (or tampering) somewhere.

ASLR: Adding Address Space Layout Randomization. Since no pointers get passed between kernel and user, the code that constructs page tables for the user can arbitrarily decide on the user's address space layout based on a per-device or per-boot random seed. Even code can be at random locations if it's compiled with PIC support; it is only DMA regions that need to be identically mapped. In addition, there should always be at least one unmapped page between accessible regions to make it impossible to overflow from one region into another, and the stack should be mapped far away from anything else, so that a constructed index into an unbounded array on the heap cannot cause a stack access and vice versa. Since the full address space is available, and any of the segments (code, input, output, stack, MMIO) can be mapped to the start of any page in address space, this would mean about 1 million different positions per segment (on a system with 4 KB pages and a 32 bit address space), which is 20 bits of entropy. With these ideas, Return-to-Lib will be practically impossible.

DMA Overflow: It might be possible for an attacker to do a bigger DMA transaction than intended in the original job, therefore DMA memory may always be at the very top of physical RAM. Any DMA overflow will then access unmapped address space.

Robust Fault Handling: In case of a fault in unprivileged mode, there are several conditions that have to be met:

1) The fault address was 0. The PC is 0

2) The LR is 0 (on architectures that have a link register) The SP points to the original top of stack.

If all these conditions are met, the fault was a return to main code flow. Otherwise (also in the case of faults other than page faults), the system may panic. This panic may prevent exploit code from doing an early return by jumping at 0.

Finer Grained Memory/Stack/MMIO Access: Typical MMUs only allow a quite coarse page granularity. By setting up an invalid page table, every memory access in unprivileged mode will fault, giving the kernel code the ability to enforce address space security with byte granularity. This could also enable the kernel code to prevent all stack-based accesses that are above the stack pointer. Unfortunately, this adds a lot of complexity to the fault code.

Hardware Side Effects: If two jobs access the same MMIO area, it could be possible for one job to send data to another job by hiding them in hardware state. It could also be possible for one job with certain hardware privileges to set up some hardware state, and another job with different privileges to initiate a hardware function. Therefore, a second job may be run after each job with MMIO access: This job has the same MMIO privileges, and it sanitizes hardware state.

Glitching: Although this design is only to prevent software attacks, it is easy to counter the most common new hardware attack: Glitching. Every “BEQ panic” may be followed by:

BNE 1f; B panic; 1:

This way, it is necessary to glitch more than one instruction, which is significantly harder than glitching one.

Panic: There are many potential implementations to the panic code:

1) spinning Drawback: an attacker could attach to the busses, pretend to be the CPU and do fetches in order to

2) extract certain secrets from the hardware

3) shut down the system. Drawback: it can take a while until power is finally off, meaning the code has to spin until power if off, so an attacker can extract some data in that time frame reset the system immediately. Drawback: automated fuzzing gets a free retry without having to detect the fault and resetting manually.

4) turn off all devices (ROM, crypto keys)

5) turn off all devices, then initiate a power down and spin with interrupts off

Second stage bootloader as a plugin: What is the second stage bootloader today may be implemented as a plugin of the secure ROM, i.e. a small piece of unprivileged mode code (and sandboxing information) that is signed, gets loaded and executed. This code will set up RAM, so that when it is done, the secure ROM can take over again and load further code into RAM. The conventional approach would be to build the second stage bootloader from the secure ROM sources, i.e., duplicating all functionality. The former approach requires less SRAM, and avoids #ifdefs in the source.

### Exemplary Code

The following provides exemplary code for verifying the boot image. It may panic when it detects tampering. It will return if the image is bogus and it runs the image if it is verified.

```
void check_and_run_image( )
{
  memcpy(current_key, root_key, RSA_KEY_SIZE);
  if (!get_cert_chain(boot_image, cert_chain)) return;
  for (int index = 0; index < MAX_CERTS; index++)
```

if (!get_cert(cert_chain, index, cert)) break;
if (!get_cert_data(cert, cert_data)) return;
sha1_a(cert, hash1);

#ifdef CONFIG_DOUBLE_CRYPTO

sha1_b(cert, hash_control);
if (!compare_160bit(hash1, hash_control)) panic( ); /*tampered! */

#endif

if (!get_cert_sig(cert, sig)) return;
rsa_a(sig, hash2, current_key);

#ifdef CONFIG_DOUBLE_CRYPTO

rsa_b(sig, hash_control, current_key);
if (!compare_160bit(hash2, hash_control)) panic( ); /* tampered! */

#endif

if (!compare_160bit(hash1, hash2)) return;
if (!get_cert_key(cert, current_key)) return;

```
  }
  if (!get_payload_block(boot_image, payload)) return;
  if (!get_payload_data(payload, payload_data)) return;
  sha1(payload_data, hash1);
#ifdef CONFIG_DOUBLE_CRYPTO
  sha1_b(payload_data, hash_control);
  if (!compare_160bit(hash1, hash_control)) panic( ); /* tampered! */
#endif
  if (!get_payload_sig(payload, sig)) return;
  rsa(sig, hash2, current_key);
#ifdef CONFIG_DOUBLE_CRYPTO
  rsa_b(sig, hash_control, current_key);
  if (!compare_160bit(hash2, hash_control)) panic( ); /* tampered! */
#endif
  if (!compare_l60bit(hash1, hash2)) return; *(void( ))payload_data( );
  panic( );
}
```

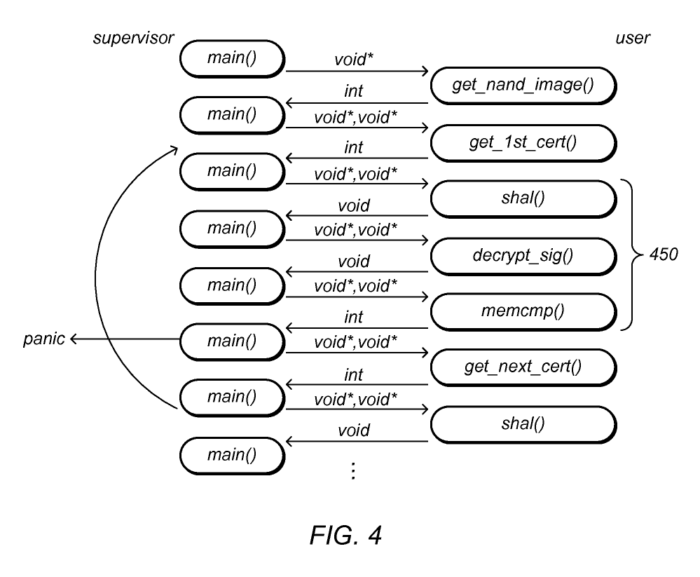

FIG. 4 is a diagram illustrating the execution of the main code of the program in supervisory mode and the functions of the program in unprivileged mode. As shown, the portions of main code on the left execute in supervisory mode. The functions on the right (get_nand_image( ), get_{—}1^{st}_cert( ), sha1( ), decrypt_sig( ), memcmp( ), get_next_cert( ), sha1( )) all execte in unprivileged mode.

The three functions sha1( ), decrypt_sig( ), and memcmp( ) 450 exemplify design principle 2, described above. Thus, instead of calling a single function to verify the loaded image, the hash function (sha1) and the signature decryption (decrypt_sig) are split. The result of these functions are compared separately in memcmp( ). Accordingly, an attacker would have to attack both sha1( ) and decrypt_sig( ) instead of a single, larger function. Although memcmp could be attacked and return a wrong result, its code is relatively simple and would be very difficult to corrupt, given the presently described design. In further embodiments, the memcmp may be performed in main memory, performed multiple times, or may be performed by hardware to reduce the ability to exploit the function.

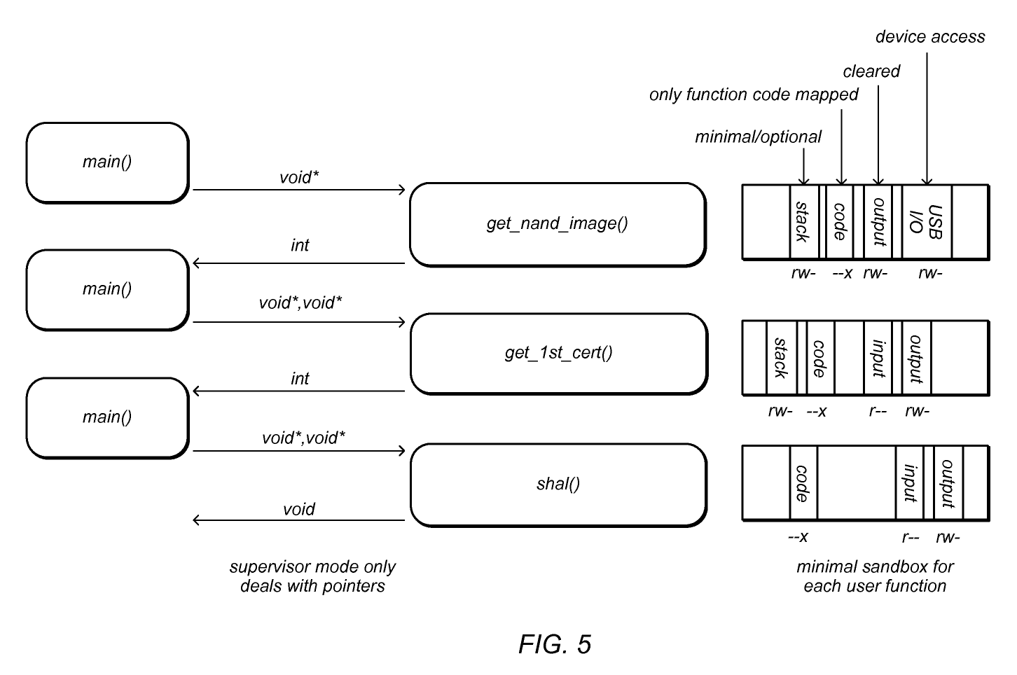

FIG. 5 illustrates exemplary function calls, functions, and constrained environments for each illustrated function. As shown, the main function may call the function get_nand_image( ). This function may be allowed read-write access to a memory address for accessing USB/IO, read-write access to an output section of memory, executable access to the function's code, and read write access to the stack. Afterwards, the constrained environment may be cleared and the function get_{—}1^{st}_cert( ) may be called. As shown, this function may be given read write access to an output portion of memory, read access to an input portion of memory (storing only the inputs of the function), executable access for the code of the function, and read write access to the stack. Finally, the function sha1( ) may have read write access to an output portion of memory, read access to an input portion of memory, and executable access to its code. As shown, the memory locations are in different locations for each of the different functions.

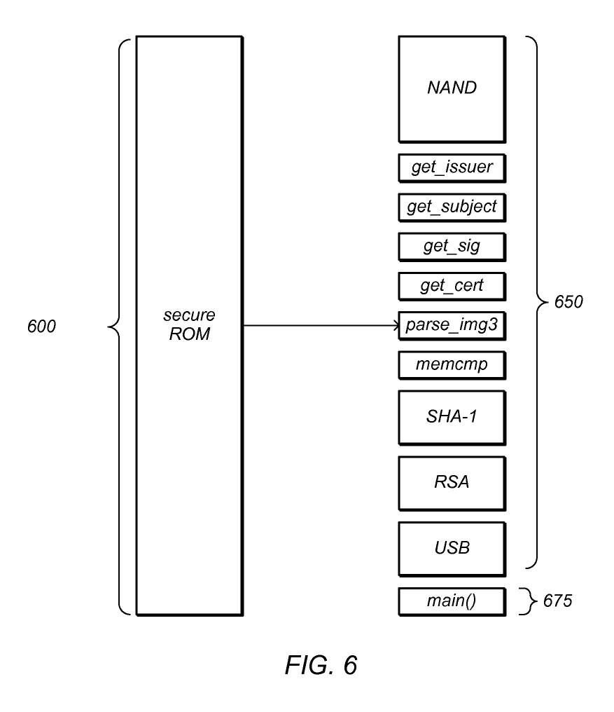

FIG. 6 illustrates the change in execution modes from previous bootloaders to one implemented using an embodiment described herein. As shown, the entire bootloader 600 was previously executed in supervisory mode. However, after switching to executing each function in unprivileged mode, only 675 is executed in supervisory mode and the functions 650 are executed in unprivileged mode, thereby providing an increased level of security.

Numerous variations and modifications will become apparent to those skilled in the art once the above disclosure is fully appreciated. It is intended that the following claims be interpreted to embrace all such variations and modifications.

What is claimed is:

1. A method for secure execution of a program, comprising:
executing the program, wherein the program comprises a plurality of function calls, wherein each of the plurality of function calls references a respective function, wherein the program is executed in a supervisory mode;
for each function call of the program, executing the respective function in a unprivileged mode.

2. The method of claim 1,
wherein for each function call of the program, said executing the respective function comprises executing the respective function in the unprivileged mode in a respective constrained environment, wherein each respective constrained environment is dedicated for each respective function.

3. The method of claim 2, wherein each respective constrained environment is customized for each respective function.

4. The method of claim 2, wherein each constrained environment is created and torn down for each function call.

5. The method of claim 1, further comprising:
establishing a respective constrained environment for each respective function being called, wherein said establishing comprises:
assigning one or more portions of memory for the respective function;
within a first portion of the one or more portions of memory, storing only inputs of the respective function;
clearing the one or more portions of the memory after the respective function completes.

6. The method of claim 1, wherein each respective function can only access data required by the respective function.

7. The method of claim 1, wherein each respective function does not receive pointers as input.

8. The method of claim 1, wherein each respective function only has privileges required for its functionality.

9. The method of claim 1, wherein each function can only access code for that function.

10. The method of claim 1, wherein the program is a bootloader.

11. A non-transitory computer readable memory medium comprising:
first program instructions corresponding to a bootloader program, wherein the first program instructions are executable by a processor to call a plurality of functions specified by the bootloader program, wherein the first program instructions are configured to execute in a supervisory mode of the processor;
second program instructions corresponding to a first function of the plurality of functions, wherein the second program instructions are configured to execute in a unprivileged mode in a first constrained environment;
third program instructions corresponding to a second function of the plurality of functions, wherein the third program instructions are configured to execute in the unprivileged mode in a second constrained environment.

12. The non-transitory computer readable memory medium of claim 11, wherein the first constrained environment is customized for the first function, wherein the second constrained environment is customized for the second function.

13. The non-transitory computer readable memory medium of claim 11, wherein the first constrained environment prevents the first function from accessing code other than that specified by the first function, wherein the second constrained environment prevents the second function from accessing code other than that specified by the second function

14. The non-transitory computer readable memory medium of claim 11, wherein the first constrained environment has a first set of privileges based on the first function, and wherein the second constrained environment has a second set of privileges based on the second function.

15. The non-transitory computer readable memory medium of claim 11, wherein prior to execution, each constrained environment is created, and wherein after execution each constrained environment is destroyed before execution of a next function.

16. A method for secure execution of a program, comprising:
executing the program, wherein the program comprises a first function call which calls a first function, wherein each of the plurality of function calls calls a respective function, wherein the program is executed in a supervisory mode;
the program calling a first function, wherein the first function executes in a first sandbox;
the program calling a second function, wherein the first function executes in a second sandbox;

17. The method of claim 16, further comprising:
creating the first sandbox prior to executing the first function;
destroying the first sandbox after executing the first function;
creating the second sandbox prior to executing the second function and after destroying the first sandbox; and
destroying the second sandbox after executing the second sandbox.

18. The method of claim 17, wherein said creating the first sandbox comprises:
assigning one or more portions of memory for the first function, wherein said assigning comprises one or more of:
assigning a first portion of the memory for storing only inputs of the respective function;
assigning a second portion of the memory for storing only outputs of the respective function; or
assigning a third portion of the memory for accessing devices;
wherein said destroying the first sandbox comprises:
clearing the one or more portions of the memory after the first function completes.

19. The method of claim 16, wherein the first sandbox is customized for the first function, wherein the second sandbox is customized for the second function.

20. The method of claim 16, wherein the first sandbox has a first set of privileges based on the first function and wherein the second sandbox has a second set of privileges based on the second function.

21. A system, comprising:
a processor, wherein the processor provides a supervisory mode and a unprivileged mode;
a memory management unit (MMU) coupled to the processor, wherein the MMU is configured to provide access to devices of the system in response to a memory address; and
one or more memories coupled to the MMU, wherein the one or more memories store a bootloader for the system, wherein the bootloader comprises a plurality of functions for performing initialization of the system, wherein the bootloader executes in the supervisory mode to call the plurality of functions, and wherein each function of the plurality of functions is configured to execute in the unprivileged mode in a respective constrained environment.

22. The system of claim 21, wherein the one or more memories comprise:
a read-write memory (RWM) coupled to the MMU, wherein the RWM is configured for storing information during operation of the system;
a read only memory (ROM) coupled to the MMU, wherein the ROM stores at least a portion of the bootloader for the system, wherein the bootloader is configured to execute using the RWM.

23. The system of claim 21, wherein the one or more memories comprise a plurality of memories, wherein the bootloader is distributed across the plurality of memories.

24. The system of claim 21, wherein the one or more memories comprise a read only memory (ROM).

25. A method for secure execution of a program, comprising:
executing the program, wherein the program is executed in a supervisory mode, wherein the program comprises a plurality of function calls, wherein each of the plurality of function calls references a respective function, wherein the plurality of function calls comprise a first function call to a first function to create a hash of stored data, a second function call to a second function to decrypt a signature corresponding to the stored data, and a third function call to a third function to verify the stored data by comparing the signature to the hash;
for each function call of the program, executing the respective function in a unprivileged mode, wherein said executing the respective function comprises executing the first function, executing the second function, and executing the third function.
